(19) United States
(12) Patent Application Publication
(10) Pub. No.: US 2007/0260993 A1
(43) Pub. Date: Nov. 8, 2007

(54) Method and system including a graphic user interface

(76) Inventors: Stanley Ted Jefferson, Palo Alto, CA (US); John C. Eidson, Palo Alto, CA (US); Dietrich Werner Vook, Los Altos, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/429,891

(22) Filed: May 8, 2006

(51) Int. Cl. G06F 3/00

(52) U.S. Cl. 715/762

(57) ABSTRACT

A method of specifying the coordination of activities and correlation of data in a distributed system is described. A computer readable medium and a system are also described.

### BACKGROUND

The coordination of activities and correlation of data in distributed systems provides challenges to system designers. For example, it is often necessary to ensure that certain events occur at the same time, or that events occur at specific times, or that events occur at specific time intervals relative to each other, or that some minimum amount of time elapses between two events. The simultaneity and desired timing of events is often a consideration in measurement and testing and industrial automation, to name only a few applications.

Known methods for coordination of activities and correlation of data in distributed systems often treat time as data. For example, in at least one known system, time must be gathered as data and added to other time components in order to have a particular operation occur. This requires the user or programmer to actively determine certain points in time. As will be appreciated, such methods are less than user-friendly.

There is a need, therefore, to provide apparati and methods of constructing events in time that overcome at least the shortcoming of known methods discussed above.

### DEFINED TERMINOLOGY

The terms ‘a’ or ‘an’, as used herein are defined as one or more than one.

The term ‘plurality’ as used herein is defined as two or more than two.

### SUMMARY

In accordance with an illustrative embodiment, a method of coordination of activities and correlation of data in a distributed system includes receiving a user input specifying a graphical programming element (GPE) in a frame; receiving a user input specifying attachment of the GPE to a synchronization edge, or the placement of the GPE in the frame, or both; and translating a graphical program into a executable code for one or more devices of the system.

In accordance with another illustrative embodiment, a computer readable medium is adapted to cause a computer to receive a user input specifying a graphical programming element (GPE) in a frame. The computer readable medium is also adapted to cause a computer to receive a user input specifying attachment of the GPE to a synchronization edge, or the placement of the GPE in the frame, or both; and to translate a graphical program into an executable code one or more devices of a distributed system.

In accordance with another illustrative embodiment, a system includes a user interface adapted to: receive a user input specifying a graphical programming element (GPE) in a frame; receive a user input specifying attachment of the GPE to a synchronization edge, or the placement of the GPE in the frame, or both; and translate a graphical program into an executable code for one or more devices of the system.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1 is a conceptual diagram of a distributed system in accordance with an illustrative embodiment.

FIG. 2 is a conceptual view of a frame sequence in accordance with an illustrative embodiment.

FIG. 3A is a visual representation of a display configured with a graphical user interface (GUI) in accordance with an illustrative embodiment.

FIG. 3B is a visual representation of a display configured with a graphical user interface (GUI) in accordance with an illustrative embodiment.

FIG. 4A is a flow-diagram of a method of assembling frames on a display in accordance with an illustrative embodiment.

FIG. 4B is a flow-diagram of a method of assembling frames on a display in accordance with an illustrative embodiment.

FIG. 4C is a flow-diagram of a method of assembling frames on a display in accordance with an illustrative embodiment.

FIG. 4D is a flow-diagram of a method of assembling frames on a display in accordance with an illustrative embodiment.

FIG. 4E is a flow-diagram of a method of assembling frames on a display in accordance with an illustrative embodiment.

FIG. 4F is a flow-diagram of a method of assembling frames on a display in accordance with an illustrative embodiment.

FIGS. 5A and 5B are flow-diagrams of a method of translating graphical program and executing target code in accordance with an illustrative embodiment.

### DETAILED DESCRIPTION

In the following detailed description, for purposes of explanation and not limitation, illustrative embodiments disclosing specific details are set forth in order to provide a thorough understanding of the present teachings. Moreover, descriptions of well-known devices, hardware, software, firmware, methods and systems may be omitted so as to avoid obscuring the description of the illustrative embodiments. Nonetheless, such hardware, software, firmware, devices, methods and systems that are within the purview of one of ordinary skill in the art may be used in accordance with the illustrative embodiments. Finally, wherever practical, like reference numerals refer to like features.

The detailed description which follows presents methods that may be embodied by routines and symbolic representations of operations of data bits within a computer readable medium, associated processors, microprocessors, digital storage oscilloscopes, general purpose personal computers, manufacturing equipment, configured with data acquisition cards and the like. In general, a method herein is conceived to be a sequence of steps or actions leading to a desired result, and as such, encompasses such terms of art as “routine,” “program,” “objects,” “functions,” “subroutines,” and “procedures.”

The apparatuses and methods of the illustrative embodiments are described in implementations in a measurement system including one or more testing devices (e.g., oscilloscopes, waveform generators and logic analyzers). Machines that may perform the test functions according to the present teachings include those manufactured by such companies as AGILENT TECHNOLOGIES, INC., HEWLETT PACKARD, and TEKTRONIX, INC. as well as other manufacturers of test and measurement equipment.

However, the apparatuses and methods of the present teachings are more broadly applicable. For illustrative purposes, it is contemplated that the present teachings are applicable to computers, sensors, actuators, robotics, mobile phones and other technologies that require synchronization and relative timing of actions, or the absolute timing of actions, or both. Notably, the methods and apparatuses of the present teachings are contemplated for use in automated manufacture and assembly.

With respect to the software useful in the embodiments described herein, those of ordinary skill in the art will recognize that there exist a variety of platforms and languages for creating software for performing the procedures outlined herein. Certain illustrative embodiments can be implemented using any of a number of varieties of operating systems (OS) and programming languages. For example, the OS may be a commercially available OS from Microsoft Corporation, Seattle, Wash., USA, or a Linux OS. The programming language may be a C-programming language, such as C++, or Java.

In accordance with certain embodiments described herein, a graphical programming editor is implemented in Java. Moreover, the compiler is implemented in Java as well. However, those of ordinary skill in the art also recognize that the choice of the exact platform and language is often dictated by the specifics of the actual system constructed, such that what may work for one type of system may not be efficient on another system. In other applications, the choice of platform and language(s) are merely the choice of the implementer, with many fungible alternatives.

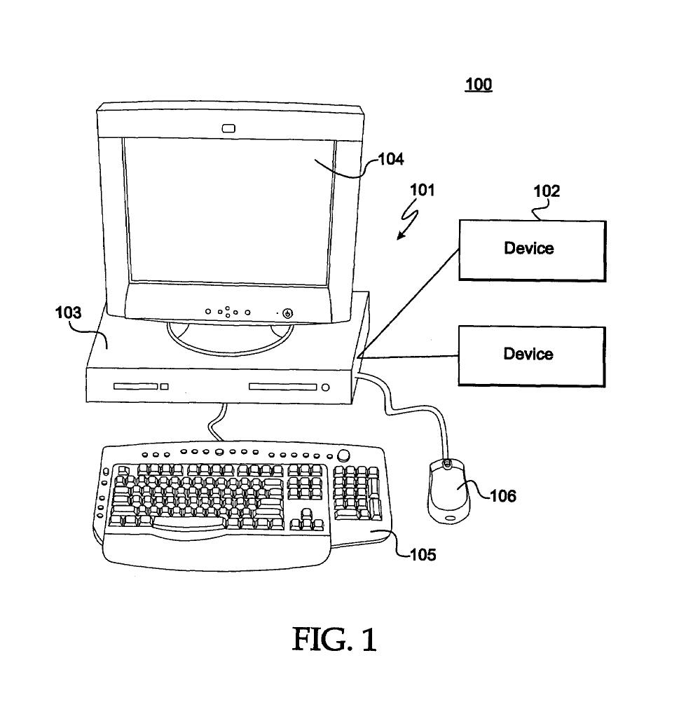

FIG. 1 is a conceptual diagram of a distributed system 100 in accordance with an illustrative embodiment. The system includes an interactive computer system (ICS) 101 and at least one device 102. The ICS 101 shown in FIG. 1 is a personal computer including a computer 103, a display 104, a keyboard 105 and a mouse 105. The computer 103 includes an OS, graphical programming editor. The graphical programming editor implemented in a programming language over the OS provides a graphical user interface (GUI). The compiler is adapted to translate the graphical program constructed with the graphical programming editor into suitable executable code for the distributed system 100. The executable code may send messages and commands to the devices 102 of the system 100. Alternatively, or additionally, the ICS 101 may provide target code for the devices 102.

The selection of a computer with a display to illustrate certain features of the present teachings is merely illustrative. In particular, the ICS 101 is portrayed as a personal computer or other similar terminal. The present teachings contemplate the ICS 101 implemented in other known devices. For example, the ICS 101 may be a portable computer, a portable digital assistant (PDA) or even a mobile telephone. Naturally, these alternative ICSs will include the requisite hardware, software and, if needed, firmware, to function in accordance with the present teachings. In many instances, present portable computers, PDA and mobile phones include such hardware and software, or will likely in the future, given the predictions of Moore's Law.

The devices 102 may be test equipment, such as oscilloscopes, optical interferometer measurement devices and logic analyzers. As noted this is merely illustrative of the application of the GUI of the illustrative embodiments. As required, some or all of the devices 102 may be connected together and some or all of the devices 102 may be connected only to the ICS 101. Such configurations are dictated by the application and are not discussed more fully to avoid obscuring the description of the embodiments.

As noted, the devices 102 may accept commands, or may be adapted to have code downloaded thereto, or may be adapted for both. Commands and/or programs may be communicated to the devices 102 via a communication channel. The devices 102 may send data to other devices 102 or ICS 101 via communication channels.

An example of a device 102 that accepts commands is an Agilent 33220A function generator. Like many test instruments, the Agilent 33220A function generator can be configured and operated using Standard Commands for Programmable Instrumentation (SCPI) commands sent over a communication channel from another device 102 or ICS 101. The Agilent 33220A function generator can also be configured and operated via IVI (Interchangeable Virtual Instrument) driver software running on a computer such as ICS 101.

Examples of devices 102 that allow for having code downloaded include, but are not limited to some computers and some mobile phones. For example, some mobile phones allow Java code to be downloaded to them to extend their capabilities.

Notably, the devices 102 that are programmable are not necessarily the same and thus the compiler is adapted to translate the graphical program into the respective target code for each respective target device 102. Moreover, instead of, or in addition to providing executable code to external devices (e.g., devices 102), the ICS 101 may provide executable code for coordination of activities and correlation of data of its functions. Moreover the executable code running on ICS 101 or a device 102 may configure or operate other devices 102 via commands or drivers (as in the case of controlling an Agilent 33220A function generator).

The ICS 101 is connected to the device(s) 102 via a wired, wireless or fiber-optic link. The link between the ICS 101 and the device 102 may be through one of a variety of standards/protocols known to those skilled in the art. For example, the link may be a local area network (LAN), a wide area network (WAN), or a wireless local area network (WLAN) to name only a few possible configurations. One skilled in the art will appreciate that one or more of a variety of standards/communications protocols may be used to implement the LAN, WAN or WLAN. It is also contemplated that the link between the ICS 101 and device(s) 102 may be carried out via a General Purpose Interface Bus (GPIB) as defined by IEEE 488, or via Universal Serial Bus (USB), or via IEEE 1394.

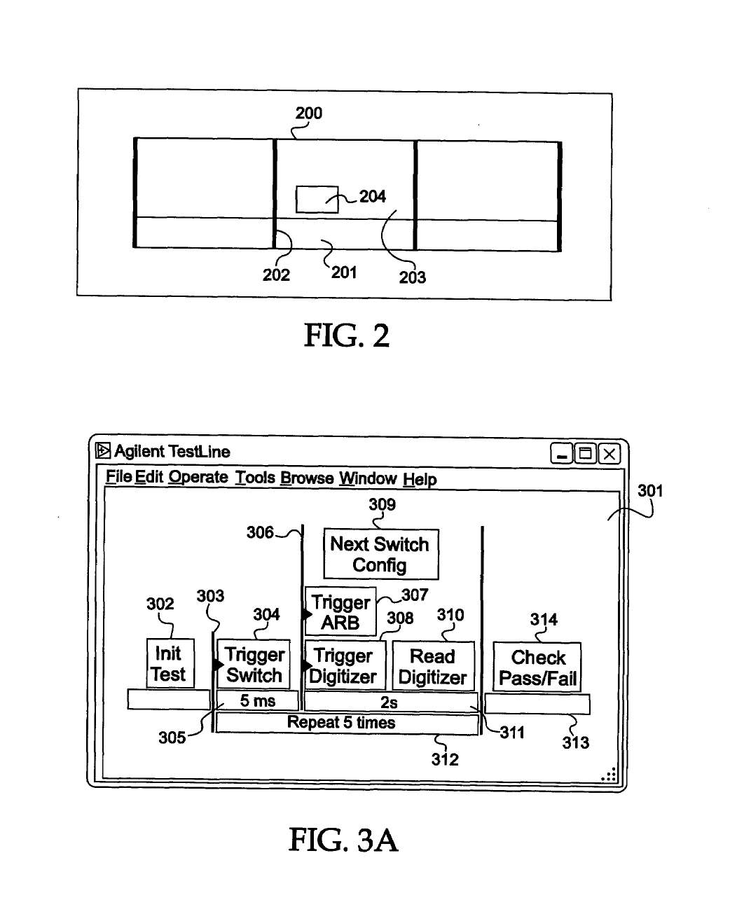

FIG. 2 is a conceptual view of a frame sequence according to an example embodiment. There are three frames shown in FIG. 2, with the middle frame 200 annotated. A region 201 is provided in the frame and allows the user to input a timing element and, optionally, one or more control elements. Each timing element includes a start field and a duration field, which allow the user to optionally input a start time (@s) and a duration time (t), respectively. A frame can also include a control element(s). Control elements enable control constructs to be associated with a frame. The control elements include control fields in which the control constructs are specified.

The inputs to the timing and control elements may be selected from a drop-down menu(s), input via a “wizard” dialog sequence, or provided as a dedicated input in the field or region 201. In an illustrative embodiment the specification of a start time literal (absolute) value would be human readable and could be based on International Standard ISO 8601. Provision is made so that the start and duration times can be expressions that reference program variables. The duration time is a logical constraint on its associated frame that can either specify that the frame has an exact duration or a duration less than some value. For example, if the duration is given as “5 ms” or “=5 ms”, then the duration of the frame is exactly 5 ms, whereas, if the duration is given as “<5 ms” then the duration of the frame can be any period of time less than 5 ms.

A synchronization edge 202 is also shown in the frame 200. As described more fully herein, the synchronization edge 202 allows the user to select and attach certain functions to occur beginning at the same time. The frame 200 includes a frame interior 203 in which one or more graphical programming element (GPE) 204 may be provided.

In the presently described embodiment, GPEs 204 are associated with a computation, procedure, function, programming control construct, graphical programming construct, event or action. An example of GPEs that could be included are the blocks and constructs of the Agilent VEE graphical programming language. In general, the GPEs of the illustrative embodiments include a variety of graphical constructs, other than a synchronization edge, that can be attached to a synchronization edge or placed in the interior of the frame. For example, a frame sequence, which is one or more frames in a horizontal row, is also a GPE of illustrative embodiments. GPEs of the illustrative embodiments may be provided in frames via drop down menus, moveable icons, pallets of moveable icons, and other similar methods implemented via the graphical program of the illustrative embodiments.

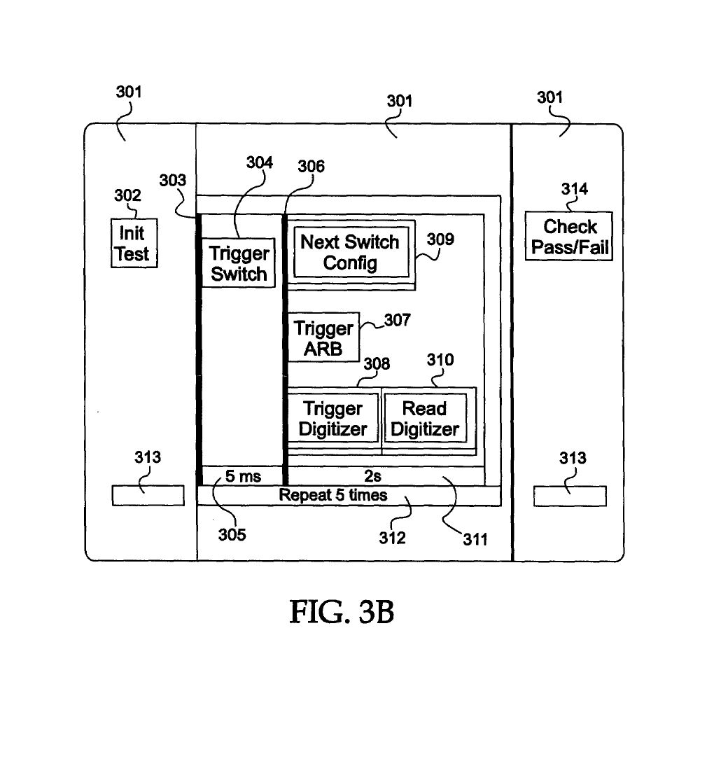

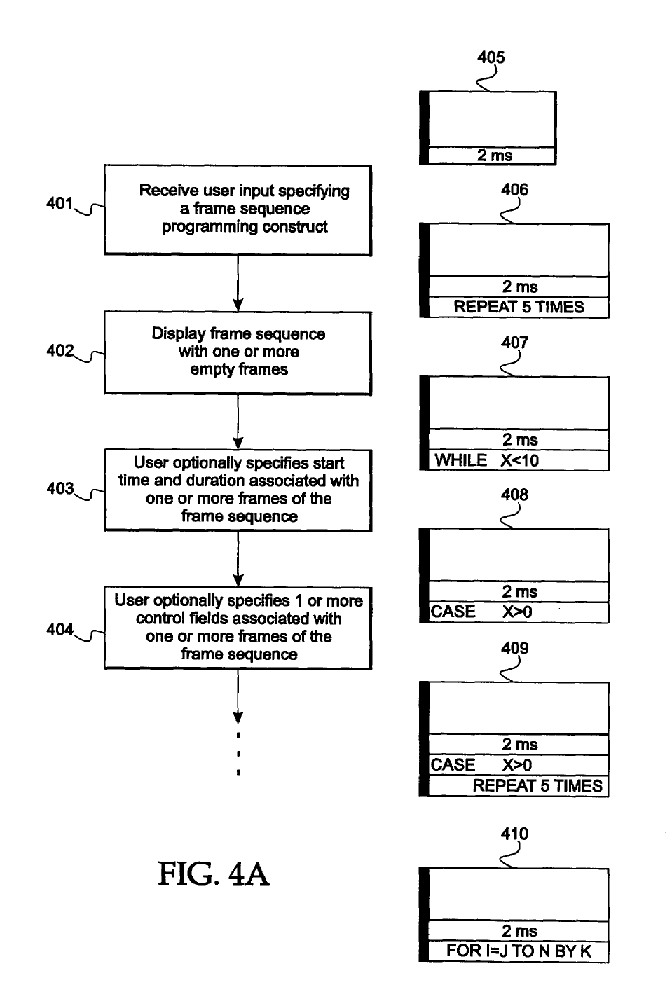

FIG. 3A is a visual representation of the display 104 configured with a graphical user interface (GUI) in accordance with an illustrative embodiment. In the illustrative embodiment, the GUI is implemented in a testing environment. The display 104 shows a plurality of frames 301, with frames being separated by synchronization edges. Furthermore, the GPEs noted are useful in carrying out functions known to those skilled in the testing and measurements arts and are not described more fully to avoid obscuring the description of the present embodiments. Finally, the functions effected by the GUI of the illustrative embodiments are not limited to those illustrated and others known to those skilled in the art are contemplated.

The frames 301 includes an initialization test element (Init Test) 302, which is followed by a first synchronization edge 303 to which a trigger switch GPE 304 is attached. The frames 301 may also include timing elements that often specify, inter alia, start times (start field), duration of a frame (duration field), as described above. For example, the frame containing trigger switch GPE 304 includes a timing element 305 having a specified duration. Moreover, the frames 301 optionally include one or more control elements that allow control constructs to be associated with a frame.

In the illustrative embodiment, the timing element 305 has a duration of 5.0 ms. It is contemplated that the time duration of a timing element may be specified to occur in less than a finite duration of time (e.g., <5.0 ms). In addition, if there is no duration specified, the associated frame may take as much time as is necessary to complete.

A second synchronization edge 306 follows on the termination of the timing element 305. The edge 306 has a trigger ARB GPE 307. (As is known, a trigger arbitrary waveform generator is often referred to as a trigger ‘ARB.’) and a trigger digitizer GPE 308 attached thereto. As such, 5.0 ms after the initiation of the first synchronization edge 303, the ARB and digitizer are simultaneously initiated.

A Next Switch Configuration GPE 309 is provided after the commencement of the GPEs 307,308 and a Read Digitizer GPE 310 follows the completion of GPE 308. As shown, a timing element 311 having a duration of 2.0 s is provided and specifies the time allotted for the completion of GPEs 307-310. A control element 312 is provided that requires the test sequence beginning with the trigger switch GPE 304 and terminating with the expiration of the duration of timing element 311 to be repeated five (5) times.

In the presently described embodiment, timing elements 313 have an unspecified duration field. As such, the corresponding frame terminates when all of the GPEs in the frame terminate. A check pass/fail GPE 314 is provided in one of the frames 301 as shown. Thus, after the quintuple repetition of the steps described above, the check pass/fail sequence is initiated.

FIG. 3B is a visual representation of the display 104 configured with a graphical user interface (GUI) in accordance with an illustrative embodiment. The visual representation of FIG. 3B is substantively the same as that described in connection with FIG. 3A. For example the framed sequence performs a stimulus/response test five times, and 5.0 ms are provided after the switch is triggered for it to settle. Immediately thereafter, the ARB and Digitizer GPEs provide triggering at the same time, and two seconds are allowed for waveform generation and response. In addition, the read digitizer is sequenced after triggering the digitizer.

However, FIG. 3B is based on a formal graphical representation. The GUI of the embodiment of FIG. 3B includes items such as nested frame sequences. Because nested frame sequences could lead to visual clutter, the formal graphical representation could be extended with abbreviated representations or graphical “sugar.” Notably, FIG. 3A represents a ‘sugared’ version of the example of FIG. 3B.

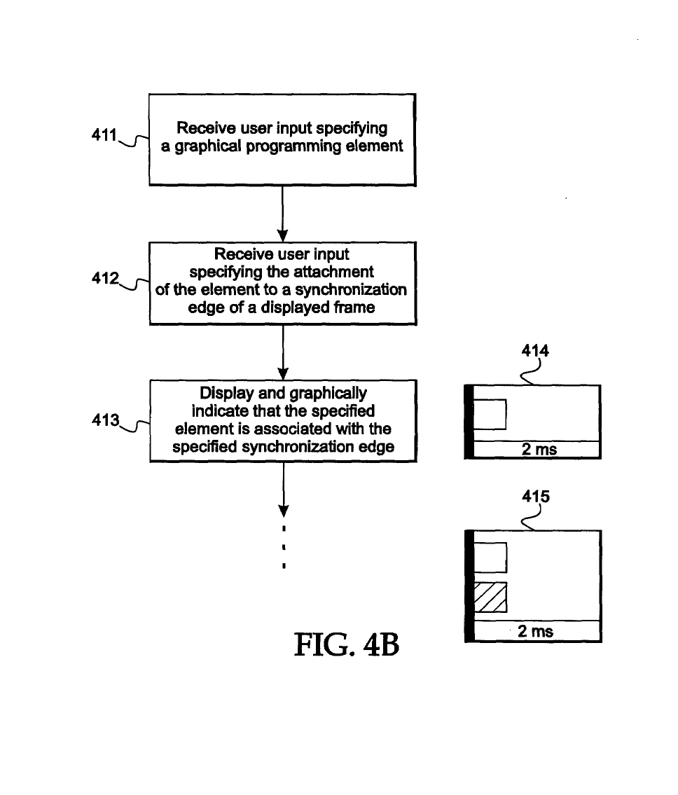

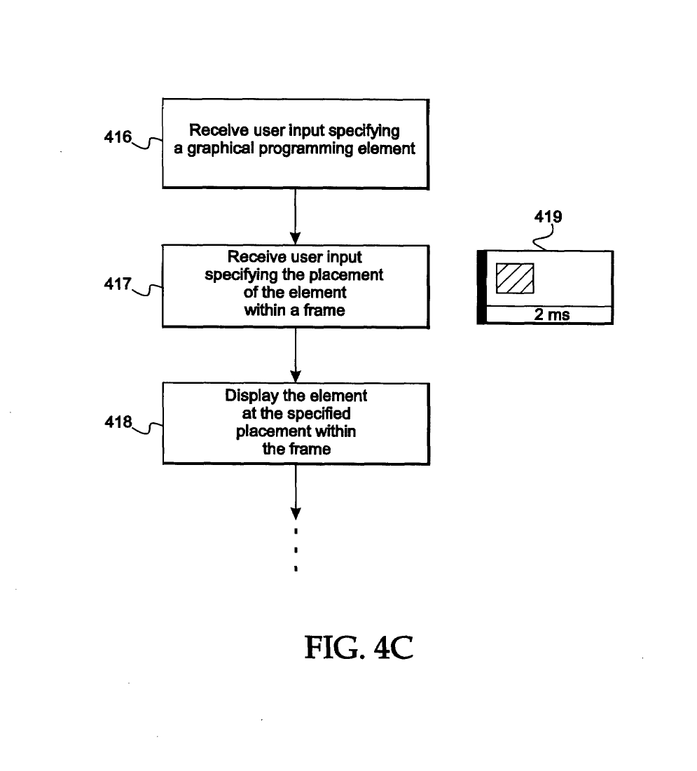

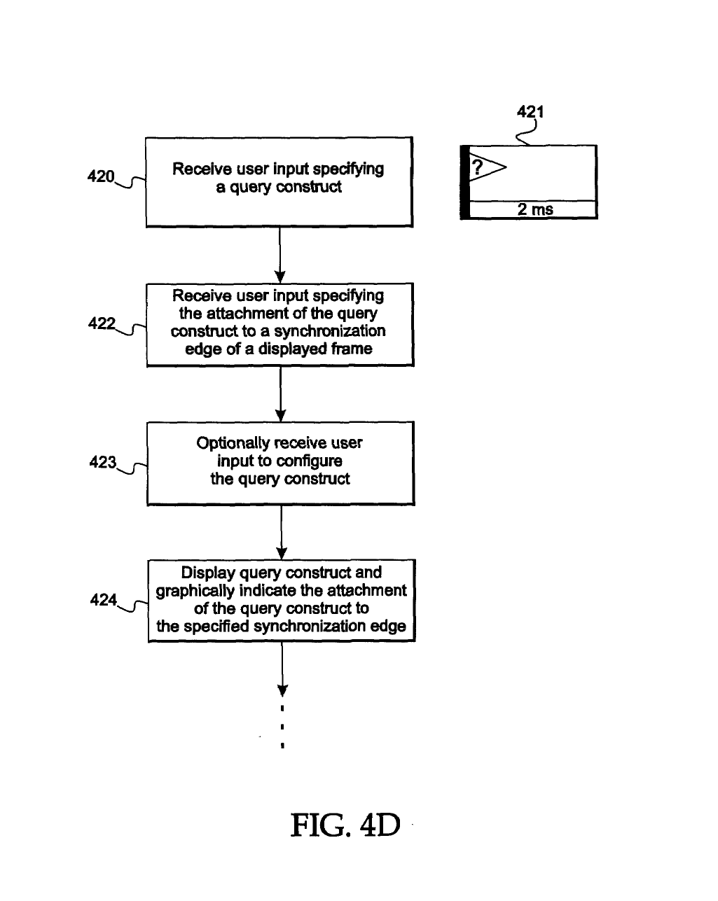

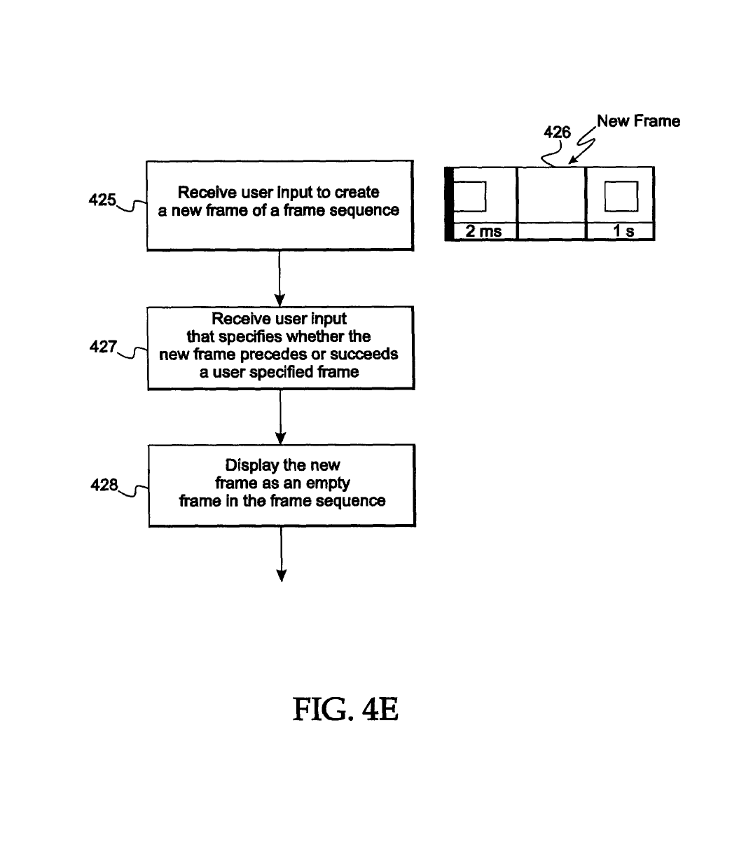

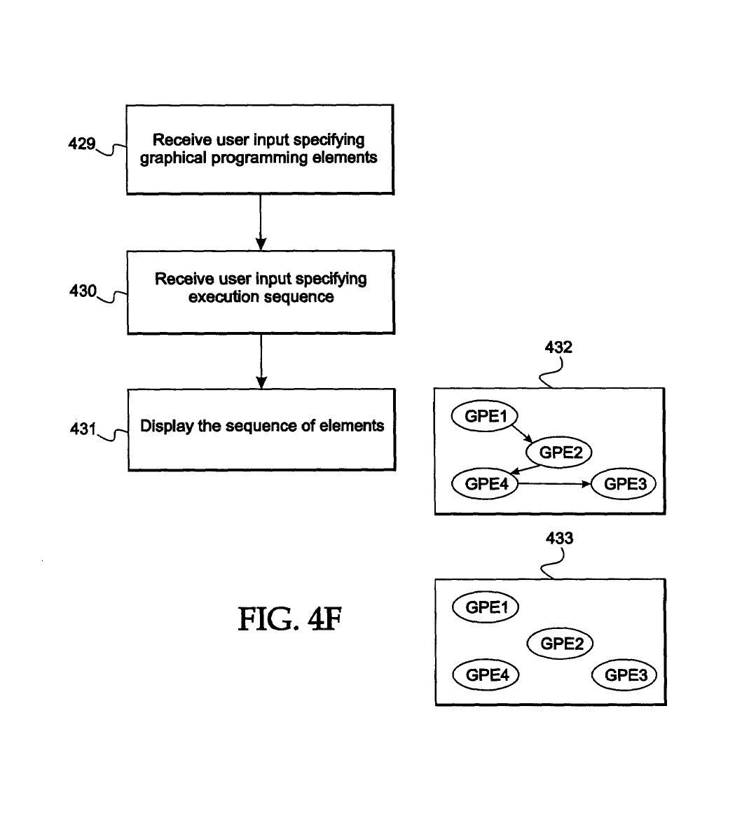

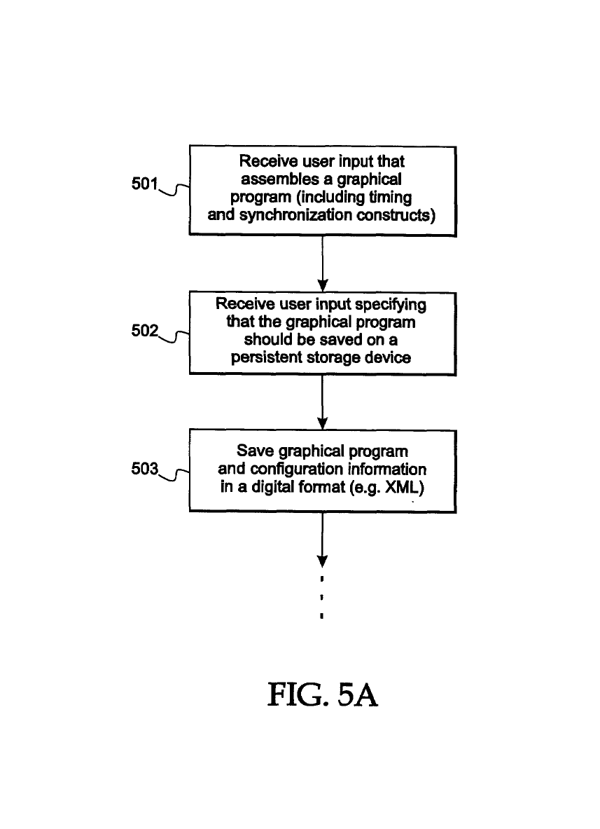

FIGS. 4A-4F show a sequence of assembling a sequence of GPEs in frames in accordance with illustrative embodiments. Notably, the visual representation shown in FIG. 3B may be constructed in accordance with the sequence of FIGS. 4A-4F. To a great extent, the methods described reflect the frames, GPEs, synchronization edges, timing elements, and control elements described previously. Thus, certain repetitive descriptions are often omitted. Furthermore, it is emphasized that the order of description is not necessarily the required order of implementation. As such, the order of steps and groups of steps may be different than that described. In addition, it is noted that once a frame, GPE, timing element, or control element is constructed, it may be revised, and/or copied, and/or moved to another frame(s) or within the same frame.

At step 401 in FIG. 4A, the method commences with the graphical programming editor receiving user input specifying a frame sequence programming construct. This is the commencement of a specification of a testing sequence or manufacturing sequence, for example, and begins the construction and display of frames, GPEs and synchronization edges at the ICS 101 using drop down menus, or moveable icons, or palettes of moveable icons, or fields, or other graphical tools, or a combination thereof, of the graphical programming editor implemented in the ICS 101. At step 402, a frame sequence with one or more empty frames are provided at the display 104.

Using similar operations, at step 403, the user optionally specifies start times and duration times in the start fields and duration fields, respectively, of the timing elements of the frame or frames of the frame sequence constructed in steps 401,402. The culmination of the constructs to this point is shown as frame 405 and includes a synchronization edge and a duration GPE of 2.0 ms.

At step 404, the user optionally specifies one or more control elements with one or more frames of the frame sequence. As noted previously, a frame can have zero or more control elements associated with it. A control element enables control constructs to be associated with a frame.

Frames 406-410 illustrate how some common programming language control constructs would be associated with a frame. It is emphasized that the frames described are merely illustrative and that frames to carry out other functions known to those skilled in the art are contemplated.

Frame 406 shows a REPEAT control field. The REPEAT control field specifies that the frame should be repeated 5 times before starting the next frame. There is also a duration of 2 ms associated with the frame. Each repetition of the frame is specified to take 2 ms.

Frame 407 illustrates a WHILE control field attached to a frame. The WHILE control field specifies that the frame should be repeated as long as the value of the program variable X is less than 10.

Frame 408 illustrates a CASE control field attached to a frame. The CASE control field determines whether the frame is executed. If the Boolean expression following the keyword CASE is true then the frame is executed, otherwise the frame is skipped and the next frame is considered for execution. Frame 408 is executed if the program variable X is greater than zero.

Frame 409 illustrates both CASE and REPEAT control fields attached to a frame. Each repetition of the frame evaluates the CASE control to determine whether it should execute.

Frame 410 illustrates a FOR control field attached to a frame. The FOR control field corresponds to the conventional FOR loop programming construct found in Pascal or Visual Basic. The frame is repeated until the program variable I is greater than program variable N. Each time the frame is repeated, the value of I is updated and made available to the contents of the frame.

FIG. 4B shows a method of constructing a frame in accordance with an illustrative embodiment and may continue from step 404 or begin with a new construct. At step 411, the user specifies a GPE for inclusion in the frame. In step 412, the graphical programming editor receives the user input specifying that the GPE is to be attached to synchronization edge of the frame and in step 413; and the graphical programming editor displays the graphical indicating that the GPE is associated with the specified synchronization edge. In an embodiment, the GPE is selected via the user interface of the graphical programming editor on the OS and attached to the synchronization edge. A frame 414 shows the culmination of the graphical construct to this point in the method with the timing element of the frame specifying a duration and the GPE attached to the synchronization edge.

The present teachings contemplate that more than one GPE may be attached to an edge via applications of steps 411 through 413. A frame 415 shows the culmination of the graphical construct to this point in the method with the GPE added to a frame that already had a GPE (crosshatched in the figure) attached to its synchronization edge.

FIG. 4C shows a method of constructing a frame in accordance with an illustrative embodiment, and may continue from step 413 or begin with a new construct. The method begins at step 416 with the graphical programming editor receiving a user input specifying a particular GPE to be included in the frame. At step 417, the user input is received that the GPE is to be within the frame, but not necessarily attached to a synchronization edge. Finally, at step 418, the graphical program displays the GPE at the specified placement within the frame. Frame 419 shows the frame with a GPE occurring in the frame but not attached to the synchronization edge.

FIG. 4D shows a method of constructing a frame in accordance with an illustrative embodiment, and may continue from step 418 or begin with a new construct. At step 420 the graphical programming editor receives a user input specifying a query construct. At step 422, the graphical programming editor receives user input specifying the attachment of the query construct at a synchronization edge of the frame as shown in frame 421. At step 423, the graphical programming editor optionally receives a user input to configure the query construct via the graphical programming editor of the illustrative embodiments. Finally, at step 424, the graphical program displays the query construct and displays the attachment to the synchronization edge as shown in frame 421.

The query construct is useful for obtaining information associated with the synchronization edge of the frame. For example, the information could be the absolute time associated with the edge or success/failure/status information about the timing of the previous frame or synchronization at the edge. The query construct obtains the information and assigns the information to a program variable or places the value on its output port. More than one such query construct may be attached to a single edge.

FIG. 4E shows a method of constructing a plurality of frames in a sequence in accordance with an illustrative embodiment, and may continue from step 424 or begin with a new construct. At step 425, the graphical programming editor receives a user input to construct a new frame, and at step 427, the ICS 101 receives a user input that specifies whether the new frame precedes or succeeds a user specified frame. At step 428, a new frame is displayed as an empty frame in a frame sequence 426. After the new frame is constructed, the GPEs may populate the frame using one or more methods of the illustrative embodiments.

FIG. 4F shows a method of assembling frames on a display in accordance with another illustrative embodiment. In step 429 the graphical programming editor receives user input specifying GPEs for a frame. At step 430, the graphical programming editor receives user input specifying execution sequence constraints for the GPEs. At step 431, the sequence of elements is displayed. A frame 432 shows a dataflow diagram comprising GPEs GPE1, GPE2, GPE3, and GPE4.

The execution constraints of frame 432 are specified in a known dataflow notation where lines interconnecting GPEs are used to specify data dependency relationships. Some illustrative execution sequences for the plurality of GPEs in the dataflow diagram in FIG. 432 are (GPE1, GPE2, GPE4, GPE3), or (GPE1∥GPE4, GPE3∥GPE2) where ∥ is a binary operator denoting parallel execution. A frame 433 depicts a mode of operation where GPE1, GPE2, GPE3, GPE4 have the same data dependencies as in frame 432, but with the dependencies specified in a way other than graphically. As such, frame 433 is intended to correspond to the same constraints as frame 432.

In accordance with the certain illustrative embodiments, the temporal sequence of the GPEs corresponds to the ‘left to right’ order on the display and at their respective horizontal level. However, except for GPEs attached to a synchronization edge, there is no temporal correlation of GPEs at different vertical levels of a frame. In addition, in the embodiments in which a timing element specifying a duration time is provided, the GPEs of the frame are constrained to all complete within a specified time of the start of the frame, and after the synchronization edge. In addition, the elements must obey the execution constraints implied by dataflow dependencies or other explicit or implicit control mechanisms.

FIGS. 3A and 3B illustrate the noted principles of ordering and sequence of GPEs of a frame. For example, the Trigger Digitizer GPE 308 is at the same horizontal level as the Read Digitizer GPE 310, which is to the right of GPE 308 and thus occurs after GPE 308. Trigger ARB GPE 307 is at a different vertical level than Trigger Digitizer 308, but is attached to the synchronization edge 306. Thus GPEs 307,308 commence at the same time. However, there is no correlation in time between the Next Switch Config GPE 309 and GPEs 307,308 and 310, which are at a different vertical level than the GPE 309. In accordance with the present teachings, the Next Switch Config GPE 309 or any similarly constructed GPE can be executed in any manner (including sequentially, threaded, or concurrently with respect to other GPEs of the frame) as long as its execution start and end within the time period of its enclosing frame.

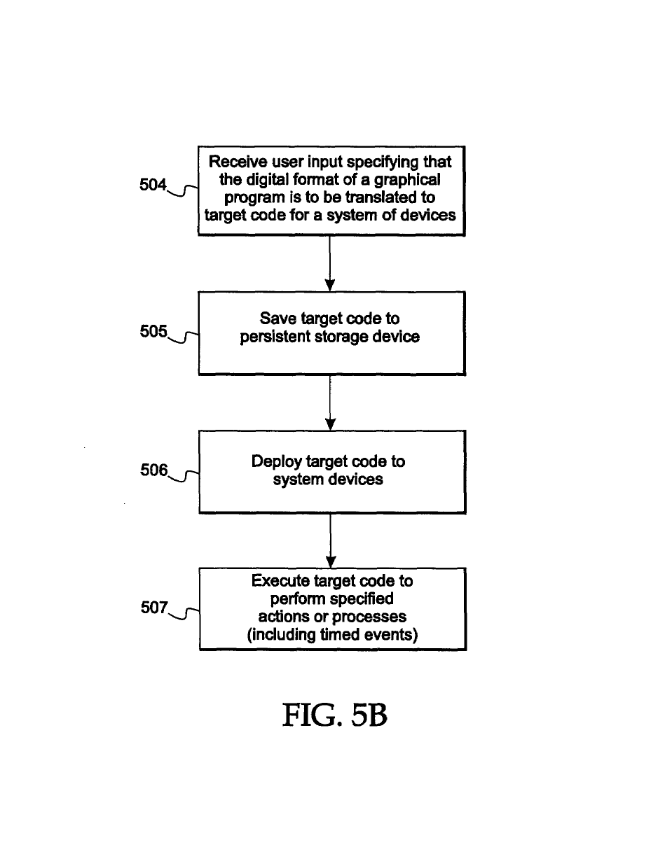

FIGS. 5A and 5B are flow-diagrams of a method of compiling and translating the graphical program of the graphical programming editor into suitable executable code for the distributed system 100. As noted previously, the executable code may send messages and commands to the devices 102 of the system 100. Alternatively, or additionally, the graphical programming editor may be used to write programs for the devices 102 that are adapted to download executable code.

The method includes compiling the graphical program with a compiler of the graphical programming editor into an intermediate code such as C or C++ and then subsequently compiling the intermediate code into executable target code (e.g., machine language) for each of the respective devices 102, using different compilers for different executable targets. The method can be adapted to work with devices that are configured to execute with either software or firmware (for example, field programmable gate arrays (FPGAs)), or a combination of the two. In the case of firmware, VHDL or Verilog may be generated as intermediate code, and executable code would be generated using the conventional synthesis, place and route tool chain.

At step 501, the graphical programming editor receives user input that assembles a graphical program based on the GPEs, synchronization edges, timing elements, control elements and other components of the frames constructed via the methods of FIGS. 4A-4F. At step 502, the graphical programming editor receives a user input that the graphical program should be saved into a disc file or other persistent storage device. At step 503, the graphical programming editor saves the graphical program and configuration information in a digital format. In an embodiment, XML is used as a digital format. However, other digital formats are contemplated.

At step 504, the ICS 101 or graphical programming editor receives a user input specifying that the digital format of the graphical program stored in step 503 is to be compiled into target code(s) for the ICS 101 and the devices 102 of the system 100. The ICS 101 then compiles the graphical program. In a programming environment, typically a framed sequence would be input to the compiler, which would generate code (software or firmware) for a target networked distributed system consisting of several hardware devices and software components (e.g. different instruments, microprocessors, communications hardware, and operating systems). With respect to frame sequences, the compiler has two primary objectives:

1. For elements attached to synchronization edges, the messages that schedule the events corresponding to the synchronization edge must be sent and received before the scheduled time of the events. The compiler generates code to send the messages and check their timely receipt;

2. Generate code to notify the program if the execution of a frame exceeds its duration time.

Notably, known graphical programming and simulation systems usually have a construct for defining a new composite block in terms of other blocks and graphical constructs. In Simulink this definitional construct is called a subsystem, in Ptolemy, the definitional construct is called a composite actor; and in LabVIEW the definitional construct is called a subVI. The corresponding construct in textual programming languages such a C is called a procedure. In LabVIEW, for example, once a subVI is defined, the construct can be used many times in other parts of the program and can be used by other subVIs to an arbitrary nesting depth.

Notably, frames can “share” a synchronization edge and that these shared edges are treated as a single edge. An example of this occurs in FIG. 3B, where the synchronization edge of frame 308 is shared with the synchronization edge 306 of an enclosing frame. In a specification that has both framed sequences and composite blocks, the compiler or simulator performs the equivalent of expanding (or in-lining) the composite blocks to determine if any synchronization edges in a composite block are shared with a synchronization edge in the frame enclosing the composite block (viewing the top-level of the specification as a form of composite block). Shared synchronization edges can be treated as a single synchronization edge for the purpose of compiling.

A compiler for the framed sequence construct may ensure that the specified behavior is met by the generated code or the compiler may simply make a “reasonable effort.” For illustrative purposes, a “reasonable effort” compiler is briefly described. To aid debugging and tuning, a reasonable effort compiler generates code that notifies the program if there is a synchronization or timing failure. (Note that even in the case where a compiler can ensure that the specified behavior is met, a hardware failure could result in a synchronization or timing failure).

It is comparatively straightforward to generate target code for item number 2 above. It is also straightforward to generate target code that detects a timing or synchronization failure for item number 1 above.

Suppose that Fₙ and Fₙ₊₁ are consecutive frames in a frame sequence. In an embodiment, code is generated that sends a message to schedule an event associated with the synchronization edge of frame Fₙ₊₁. The code is generated so that the message is sent when all of the blocks contained in frame Fₙ have executed. This ensures that the sent message will not overwrite any pending messages. The code that checks for timely receipt and possibly retries the message send is also generated. This code generation method may fail to send the scheduled event message in time. A more sophisticated analysis by the compiler would analyze resources in order to determine if the message could be sent earlier.

At step 505, the target code is optionally saved in the persistent storage device of the ICS 101 and at step 506 the target code is deployed via the network to respective devices 102. It is contemplated that rather than continue with step 506 on the ICS 101 in which the graphical program was created, the program stored in the persistent storage device (e.g., disc) may be removed from the ICS and executed in another ICS 101. Finally, commands are provided at step 507 to execute the code to perform the designated actions or processes.

Note that a corresponding textual version of the graphical framed sequence construct could also be defined. An example Lisp-like syntax for a frame-sequence is:

(timed-sequence (timed-frame start duration <synchronized-statements><unsynchronized-statements>) . . . )

where <synchronized-statements> and <unsynchronized-statements> are lists of statements, and frame-sequence is a member of statements.

In view of this disclosure it is noted that the various methods and devices described herein can be implemented in hardware and software. Further, the various methods and parameters are included by way of illustrative only and not in any limiting sense. While certain useful aspects of the GUI of the illustrative embodiments have been described, there are clearly modifications that will be apparent to one of ordinary skill in the art having had the benefit of the present disclosure. For example, the width and height of a frame may be expanded or contracted to accommodate more or fewer GPEs, timing elements and control elements. In view of this disclosure, those skilled in the art can implement the present teachings in determining their own techniques and needed equipment to implement these techniques, while remaining within the scope of the appended claims.

1. A method of specifying the coordination of activities and correlation of data in a distributed system, the method comprising:
receiving a user input specifying a graphical programming element (GPE) in a frame;
receiving a user input specifying attachment of the GPE to a synchronization edge, or the placement of the GPE in the frame, or both; and
compiling a graphical program into an executable code for one or more devices of the system.

2. A method as claimed in claim 1, further comprising specifying at least one timing element in the frame.

3. A method as claimed in claim 1, further comprising specifying attachments of a plurality of GPEs to the synchronization edge.

4. A method as claimed in claim 1, further comprising forming another frame after the frame.

5. A method as claimed in claim 1, further comprising specifying at least one control element in the frame.

6. A method as claimed in claim 5, further comprising wherein at least one control element specifies a repetition of a frame.

7. A method as claimed in claim 1, wherein the executable code is a target code, and the method further comprises: after the compiling, providing the target code to a designated target in the system.

8. A method as claimed in claim 1, wherein the executable code sends messages and commands to the devices.

9. A computer readable medium, adapted to cause a computer to:
receive a user input specifying a graphical programming element (GPE) in a frame;
receive a user input specifying attachment of the GPE to a synchronization edge, or the placement of the GPE in the frame, or both; and
compile a graphical program into an executable code for one or more devices of a distributed system.

10. A computer readable medium as claimed in claim 9, wherein the computer readable medium is further adapted to specify at least one timing element in the frame.

11. A computer readable medium as claimed in claim 9, wherein the computer readable medium is further adapted to specify at least one control element in the frame.

12. A computer readable medium as claimed in claim 9, wherein the computer readable medium is further adapted to specify attachments of a plurality of GPEs to the synchronization edge.

13. A computer readable medium as claimed in claim 9, wherein the computer readable medium is adapted to form another frame after the frame.

14. A system, comprising:
an interactive computer system (ICS) adapted to:
receive a user input specifying a graphical programming element (GPE) in a frame;
receive a user input specifying attachment of the GPE to a synchronization edge, or the placement of the GPE in the frame, or both; and
compile a graphical program into an executable code for one or more devices of the system.

15. A system as claimed in claim 14, wherein the system is a measurement system and at least one of the devices is a measurement device.

16. A system as claimed in claim 14, wherein the system is an automated manufacturing system and at least one of the devices is a manufacturing device.

17. A system as claimed in claim 14, wherein the ICS is further adapted to specify at least one timing element in the frame.

18. A system as claimed in claim 14, wherein the ICS is further adapted to specify at least one control element in the frame.

19. A system as claimed in claim 14, wherein the ICS is further adapted to specify attachments of a plurality of GPEs to the synchronization edge.

20. A system as claimed in claim 14, wherein the ICS is adapted to form another frame after the frame.
